(19) United States
(12) Patent Application Publication
(10) Pub. No.: US 2025/0181485 A1
(43) Pub. Date: Jun. 5, 2025

(54) COMBINED TEST APPARATUS, SYSTEM, METHOD, AND COMPUTER READABLE MEDIUM

(71) Applicant: NEC Corporatio, Minato-ku, Tokyo (JP)

(72) Inventor: Ryota KUBONIWA, Tokyo (JP)

(73) Assignee: NEC Corporation, Minato-ku, Tokyo (JP)

(21) Appl. No.: 18/836,810

(22) PCT Filed: Feb. 28, 2022
(86) PCT No.: PCT/JP2022/008393

§ 371 Date: Aug. 8, 2024

(51) Int. Cl. G06F 11/3668

(52) U.S. Cl. CPC G06F 11/3676; G06F 11/3688

(57) ABSTRACT

A combined test apparatus includes: a selection unit that refers to combined test definition information in which a test automation tool and an execution order are associated with each of a plurality of test scenarios constituting a combined test for an information system and then selects the test scenario and the test automation tool in accordance with the execution order; a test execution unit that executes, for the information system, the selected test scenario by using the selected test automation tool; and a determination unit that determines whether or not the combined test has been successfully performed based on at least some of results of the execution of the plurality of the test scenarios executed in accordance with the respective execution orders.

### TECHNICAL FIELD

The present invention relates to a combined test apparatus, a system, a method, and a program.

### BACKGROUND ART

Patent Literature 1 discloses a technology related to an operation management server that executes tests by associating a work pattern corresponding to configuration information stored in a configuration management database with a test scenario for checking a result of work.

### CITATION LIST

### Patent Literature

Patent Literature 1: International Patent Publication No. WO 2018/174223

### SUMMARY OF INVENTION

### Technical Problem

In recent years, various test types of automation tools for automatic execution of software tests have begun to be widely used. However, since the above test automation tools are intended to support unit tests of software, it is still required to manually perform tests in order to perform an integration test and a system test on an information system including released software. The reason for this is that the above test automation tools do not support, for example, functional tests of service contents provided by the entire information system including released software, performance tests of the information system, and operational tests for checking exception handling in the event of a failure. Another reason is that the interfaces between the above test automation tools have not been unified, which complicates the linkage between these tools.

In view of the above-described problems, an object of the present disclosure is to provide a combined test apparatus, a system, a method, and a program for efficiently executing an integration test and a system test by linking a plurality of test automation tools with each other.

### Solution to Problem

A combined test apparatus according to a first example aspect of the present disclosure includes:
selection means for referring to combined test definition information in which a test automation tool and an execution order are associated with each of a plurality of test scenarios constituting a combined test for an information system and then selecting the test scenario and the test automation tool in accordance with the execution order;
test execution means for executing, for the information system, the selected test scenario by using the selected test automation tool; and
determination means for determining whether or not the combined test has been successfully performed based on at least some of results of the execution of the plurality of the test scenarios executed in accordance with the respective execution orders.

A combined test system according to a second example aspect of the present disclosure includes:
a storage apparatus configured to store combined test definition information in which a test automation tool and an execution order are associated with each of a plurality of test scenarios constituting a combined test for an information system; and
a combined test apparatus,
in which the combined test apparatus includes:
selection means for referring to the combined test definition information and then selecting the test scenario and the test automation tool in accordance with the execution order;
test execution means for executing, for the information system, the selected test scenario by using the selected test automation tool; and
determination means for determining whether or not the combined test has been successfully performed based on at least some of results of the execution of the plurality of the test scenarios executed in accordance with the respective execution orders.

A combined test method according to a third example aspect of the present disclosure includes:
referring to combined test definition information in which a test automation tool and an execution order are associated with each of a plurality of test scenarios constituting a combined test for an information system and then selecting the test scenario and the test automation tool in accordance with the execution order;
executing, for the information system, the selected test scenario by using the selected test automation tool; and
determining whether or not the combined test has been successfully performed based on at least some of results of the execution of the plurality of the test scenarios executed in accordance with the respective execution orders.

A combined test program according to a fourth example aspect of the present disclosure causes a computer to execute:
selection processing for referring to combined test definition information in which a test automation tool and an execution order are associated with each of a plurality of test scenarios constituting a combined test for an information system and then selecting the test scenario and the test automation tool in accordance with the execution order;
test execution processing for executing, for the information system, the selected test scenario by using the selected test automation tool; and
determination processing for determining whether or not the combined test has been successfully performed based on at least some of results of the execution of the plurality of the test scenarios executed in accordance with the respective execution orders.

### Advantageous Effects of Invention

According to the present disclosure, it is possible to provide a combined test apparatus, a system, a method, and a program for efficiently executing an integration test and a system test by linking a plurality of test automation tools with each other.

### BRIEF DESCRIPTION OF DRAWINGS

FIG. 1 is a block diagram showing a configuration of a combined test apparatus according to a first example embodiment;

FIG. 2 is a flowchart showing a flow of a combined test method according to the first example embodiment;

FIG. 3 is a block diagram showing an overall configuration including a combined test system according to a second example embodiment;

FIG. 4 is a block diagram showing a configuration of a combined test apparatus according to the second example embodiment;

FIG. 5 is a diagram showing an example of test scenario information according to the second example embodiment;

FIG. 6 is a diagram showing an example of combined test definition information according to the second example embodiment;

FIG. 7 is a flowchart showing a flow of combined test processing according to the second example embodiment;

FIG. 8 is a flowchart showing a flow of combined test execution processing according to the second example embodiment; and

FIG. 9 is a diagram for explaining a concept of an automated pipeline for configuration management, release processing, and combined test processing according to the second example embodiment.

### EXAMPLE EMBODIMENT

Example embodiments of the present disclosure will be described hereinafter in detail with reference to the drawings. The same or corresponding elements are denoted by the same reference symbols throughout the drawings, and redundant descriptions thereof will be omitted as necessary for the clarification of the description.

### First Example Embodiment

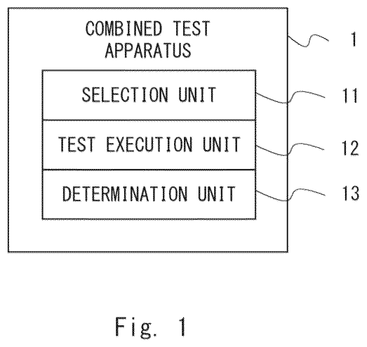

FIG. 1 is a block diagram showing a configuration of a combined test apparatus 1 according to a first example embodiment. The combined test apparatus 1 is an information processing apparatus for performing a combined test which is a combination of a plurality of test processes for an information system (not shown). The combined test apparatus 1 includes a selection unit 11, a test execution unit 12 and a determination unit 13. Note that, in the following description, it is assumed that “combined test definition information” is information in which a test automation tool and an execution order are associated with each of a plurality of test scenarios constituting a combined test for the information system.

The selection unit 11 refers to the combined test definition information and then selects the test scenario and the test automation tool in accordance with the execution order. The test execution unit 12 executes the selected test scenario for the information system by using the selected test automation tool. The determination unit 13 determines whether or not the combined test has been successfully performed based on at least some of results of the execution of the plurality of the test scenarios executed in accordance with the respective execution orders.

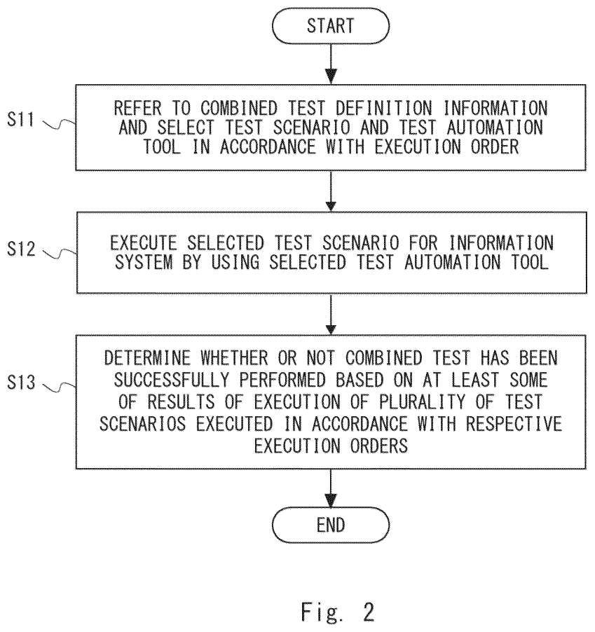

FIG. 2 is a flowchart showing a flow of a combined test method according to the first example embodiment. First, the selection unit 11 refers to combined test definition information and selects a test scenario and a test automation tool in accordance with an execution order (S11). Next, the test execution unit 12 executes the selected test scenario for the information system by using the selected test automation tool (S12). That is, Steps S11 and S12 are repeatedly executed in accordance with the execution order defined in the combined test definition information. Then the determination unit 13 determines whether or not the combined test has been successfully performed based on at least some of results of the execution of a plurality of test scenarios executed in accordance with the respective execution orders (S13).

As described above, in this example embodiment, the test scenario and the test automation tool used to execute the test scenario are previously associated with the combined test definition information and defined. The execution order of each of the test scenarios in the combined test is also associated with the combined test definition information and defined. Therefore, the combined test apparatus 1 can refer to the combined test definition information and then execute the test scenarios in accordance with the execution order. At this time, the combined test apparatus 1 can execute the test scenario by using the test automation tool associated with the test scenario. Therefore, the combined test can be automated by executing, for the information system which is a subject of the combined test, various types of different test automation tools for each of the test scenarios. That is, according to this example embodiment, an integration test and a system test (a combined test) can be efficiently executed by linking a plurality of test automation tools with each other.

Note that the combined test apparatus 1 includes a processor, a memory, and a storage device as a configuration which is not shown. Further, a computer program in which processing of the combined test method according to this example embodiment is implemented is stored in the storage device. Further, the processor loads a computer program or the like from the storage device into the memory and executes the loaded computer program. In this way, the processor implements the functions of the selection unit 11, the test execution unit 12, and the determination unit 13.

Alternatively, each of the components of the combined test apparatus 1 may be implemented by dedicated hardware. Further, some or all of the components of each apparatus may be implemented by general-purpose or dedicated circuitry, a processor, or the like, or a combination thereof. These components may be formed by a single chip or by a plurality of chips connected to each other through a bus. Some or all of the components of each apparatus may be implemented by a combination of the above-described circuitry or the like and a program. Further, a Central Processing Unit (CPU), a Graphics Processing Unit (GPU), a Field-Programmable Gate Array (FPGA), a quantum processor (a quantum computer control chip), or the like may be used as the processor.

### Second Example Embodiment

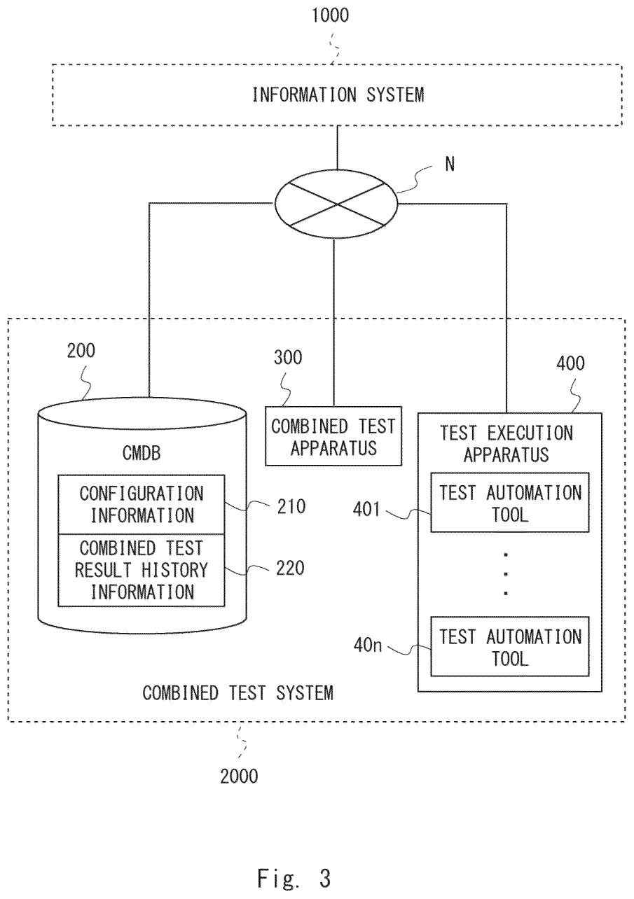

A second example embodiment is a specific example of the first example embodiment described above. FIG. 3 is a block diagram showing an overall configuration including a combined test system 2000 according to the second example embodiment. The combined test system 2000 is connected to an information system 1000 via a network N. The information system 1000 is a target system on which the combined test system 2000 executes the combined test. The information system 1000 may be a cloud system or an on-premises system, which includes at least some of a server, a network apparatus, a storage device, and the like. The network N is a communication network including a wired or wireless communication line network, a mobile phone line network, and the like. The network N may include the Internet. Further, regarding the communication network, any type of communication protocol may be used.

The combined test system 2000 includes a Configuration Management DataBase (CMDB) 200, a combined test apparatus 300, and a test execution apparatus 400. Some or all of the CMDB 200, the combined test apparatus 300, and the test execution apparatus 400 may be implemented by the same hardware. Alternatively, the CMDB 200 may be made redundant by providing a plurality of storage devices. Further, each of the combined test apparatus 300 and the test execution apparatus 400 may be made redundant by providing a plurality of computers.

The CMDB 200 is an example of a configuration management database for managing configuration information 210 of the information system 1000. The configuration information 210 includes design information in the information system 1000, various parameters to be set in the information system 1000, and information about software implemented in the information system 1000 (source codes of programs, libraries, etc.). Note that the configuration information 210 may be used as input data of a combined test or an expected value of a result of a combined test.

Further, the CMDB 200 manages combined test result history information 220. The combined test result history information 220 is information in which a history of results of a combined test for the information system 1000 is recorded. The combined test result history information 220 may include, for example, the ID of a combined test, the date and time of the execution of the combined test, a result of the combined test, and a result of the determination as to whether or not the combined test has been successfully performed. Note that a result of the combined test included in the combined test result history information 220 may be used as an expected value to be compared with a test result in the next or subsequent combined test.

The test execution apparatus 400 includes a plurality of test automation tools 401 to 40n (n is a natural number greater than or equal to two). The test automation tool 401 or the like is software that performs a unit test or the like on the information system 1000 and is an example of a test program. The test automation tool 401 or the like performs, for example, data import processing to a database or the like in the information system 1000, transmission of a specific request and reception of the response to the information system 1000, and acquisition of results of execution of tests. The test automation tool 401 or the like has a function of executing a specified test scenario to a specified destination. A plurality of types of known tools can be applied to the test automation tool 401 or the like.

The test execution apparatus 400 executes a test of the specified test scenario for the specified information system 1000 by using the specified test automation tool 401 or the like in response to an instruction from the combined test apparatus 300.

The combined test apparatus 300 is an example of the combined test apparatus 1 described above. The combined test apparatus 300 specifies a predetermined test automation tool 401 or the like and a predetermined test scenario in accordance with an instruction from the outside or at a predetermined timing and then instructs the test execution apparatus 400 to execute a test for the information system 1000. The combined test apparatus 300 may be made redundant by providing a plurality of computers, and each functional block may be implemented by a plurality computers.

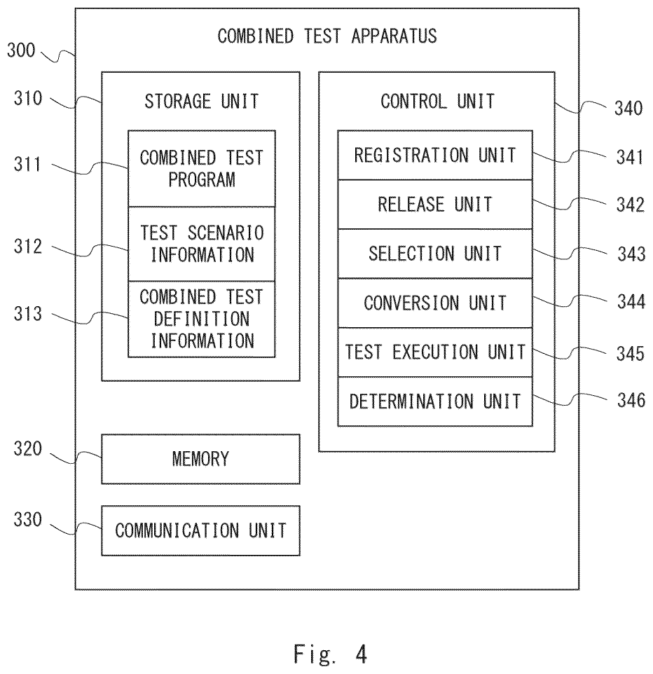

FIG. 4 is a block diagram showing a configuration of the combined test apparatus 300 according to the second example embodiment. The combined test apparatus 300 includes a storage unit 310, a memory 320, a communication unit 330, and a control unit 340. The storage unit 310 is an example of a storage device such as a hard disk or a flash memory. The storage unit 310 stores a combined test program 311, test scenario information 312, and combined test definition information 313. The combined test program 311 is a computer program in which combined test processing and the like according to the second example embodiment are implemented.

The test scenario information 312 is information in which the contents of individual test scenarios constituting a combined test, parameters used for the test, test data, and the like are defined. Each of test scenarios is a unit test that can be executed by one of the test automation tool 401 and the like, and a content of each of these test scenarios is a process or the like executed individually for the information system 1000. Further, a content of each of the test scenarios is a process independent of other test scenarios. Further, each of the test scenarios may be defined in a plurality of combined tests.

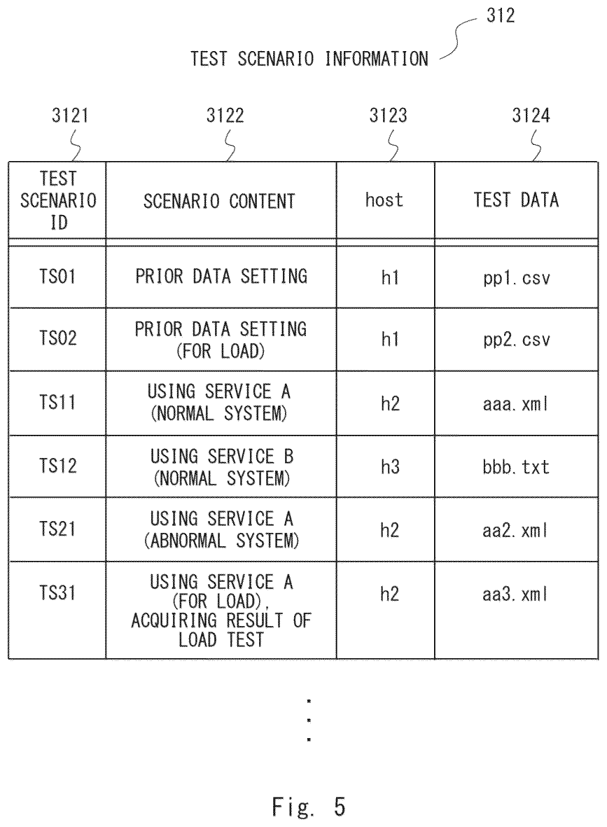

FIG. 5 is a diagram showing an example of the test scenario information 312 according to the second example embodiment. The test scenario information 312 includes, for example, a test scenario ID 3121, a scenario content 3122, a host name 3123, and test data 3124. The test scenario ID 3121 is identification information of the test scenario. The scenario content 3122 is the information indicating the content of the test scenario. The host name 3123 indicates the name of a host computer to which the test scenario is executed, and is any server or the like in the information system 1000. Note that the host name 3123 is an example of a parameter used in the test scenario. The test data 3124 is a file name or a storage destination of the test data used for the test scenario. Note that the test data 3124 may be data itself, for example, a character string or a numerical value as an input value or a setting value.

For example, the scenario content 3122 of a test scenario ID “TS01” is “prior data setting”, which indicates processing for importing test data “ppl.csv” into the database of a host “h1” constituting the information system 1000. Alternatively, the scenario content 3122 of the test scenario ID “TS01” may be processing for inputting the content of the test data “ppl.csv” into an application running on the host “h1”.

Further, for example, the scenario content 3122 of a test scenario ID “TS11” is “using a service A (normal system)”, and may be processing for inputting the content of test data “aaa.xml” into an application running on a host “h2” constituting the information system 1000.

Referring back to FIG. 4, the description will be continued.

The combined test definition information 313 is an example of information in which a test automation tool and an execution order are associated with each of a plurality of test scenarios constituting the combined test. Note that the combined test includes two or more test scenarios (e.g., jobs). Therefore, the combined test may be represented by a job flow, which is a set of a plurality of jobs in which the execution orders thereof are specified.

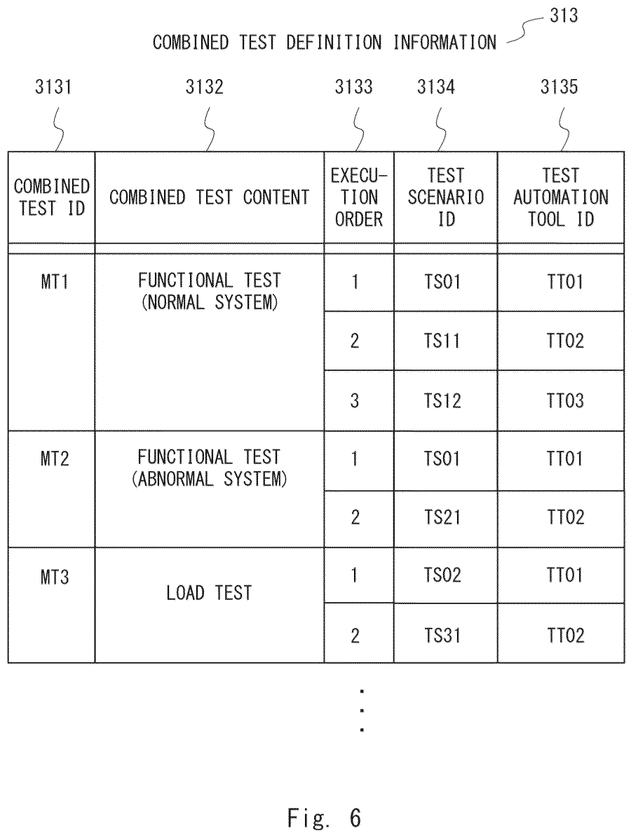

FIG. 6 is a diagram showing an example of the combined test definition information 313 according to the second example embodiment. The combined test definition information 313 includes a combined test ID 3131, a combined test content 3132, an execution order 3133, a test scenario ID 3134, and a test automation tool ID 3135. The combined test ID 3131 is identification information of the combined test.

The combined test content 3132 is information indicating content of the combined test. The content of the combined test includes, for example, a functional test, a load test, or an abnormal system test. The functional test is a combined test for verifying the function provided by the information system 1000. The functional test includes a normal system test for verifying that the function is normal and an abnormal system test for verifying that the function (exception handling etc.) is operated properly in the event of any abnormality such as an input of unauthorized data. Further, the load test is a performance measurement test for verifying performance of the information system 1000.

The execution order 3133 is information indicating the execution order of the test scenarios in the combined test, for example, by a number. Note that the execution order 3133 does not have to be a number. For example, it may be defined by a link between the test scenario IDs 3134, or may be defined by the order of the association between the combined test content 3132 and the test scenario ID 3134. The test scenario ID 3134 is information corresponding to the combined test ID 3131 of the combined test definition information 313 described above. The test automation tool ID 3135 is identification information for specifying one of the above-described test automation tools 401 to 40n.

For example, the combined test content 3132 of the combined test ID 3131 “MT1” is a “functional test (normal system)”, and defines that the test scenarios are executed in the order of “TS01”, “TS11”, and “TS12”. Further, it indicates that a test automation tool ID “TT01” is used for “TS01”, a test automation tool ID “TT02” is used for “TS11”, and a test automation tool ID “TT03” is used for “TS12”.

Referring back to FIG. 4, the description will be continued.

The memory 320 is a volatile storage device such as a Random Access Memory (RAM), and is a storage area for temporarily holding information during the operation of the control unit 340. The communication unit 330 is a communication interface between the inside and the outside of the combined test apparatus 300.

The control unit 340 is a processor that controls each component of the combined test apparatus 300, namely, a control apparatus. The control unit 340 loads the combined test program 311 from the storage unit 310 into the memory 320 and executes the loaded combined test program 311. In this way, the control unit 340 implements the functions of a registration unit 341, a release unit 342, a selection unit 343, a conversion unit 344, a test execution unit 345, and a determination unit 346.

The registration unit 341 registers the test scenario information 312 and the combined test definition information 313 in accordance with information input from an administrator terminal (not shown) operated by an administrator who manages the combined test of the information system 1000. Note that it is assumed that the administrator terminal is an information processing apparatus and is connected to the combined test apparatus 300 through the network N or directly.

Specifically, the registration unit 341 receives the scenario content 3122, the parameters such as the host name 3123, and the test data 3124, issues a unique test scenario ID 3121, associates them with each other, and then registers them in the test scenario information 312. Further, the registration unit 341 receives the combined test content 3132 and a pair of the test scenario ID 3134 and the test automation tool ID 3135 for each execution order 3133, issues a unique combined test ID 3131, associates them with each other, and then registers them in the combined test definition information 313. Further, the registration unit 341 registers a result of the determination by the determination unit 346 described later in the CMDB 200. For example, the registration unit 341 registers a result of the determination in the configuration information 210 or the combined test result history information 220.

The release unit 342, in response to an update of the configuration information 210 in the CMDB 200, generates a load module related to the updated configuration information, and updates the information system 1000 by the load module. Specifically, when (prior) checking processing, system addition setting processing, automatic release processing, status check processing (after the release is performed) of the information system 1000 have been performed and then there is no problem with regard to the status check thereof, the release unit 342 sends a release completion notification to the selection unit 343.

The selection unit 343 is an example of the selection unit 11 described above. The selection unit 343 refers to the combined test definition information 313 and then selects the test scenario ID 3134 and the test automation tool ID 3135 in accordance with the execution order 3133 in the specific combined test ID 3131. Further, after the execution of the first test scenario using the first test automation tool, the selection unit 343 selects the second test scenario, the execution order of which is later than that of the first test scenario, and the second test automation tool.

The conversion unit 344 is an example of the first conversion means and the second conversion means. The conversion unit 344 converts information about a test corresponding to the selected test scenario into a format corresponding to the selected test automation tool. Note that the “information about a test” refers to, for example, parameters and test data used for the test scenario. Further, the “format according to the test automation tool” refers to an input format of the test automation tool, an option string of an argument of an execution command of the test automation tool, an order of arguments, a format of an input file, and the like. For example, the conversion unit 344 generates an argument string in which parameters used for the test scenario are sorted in accordance with the order of arguments of the execution command of the test automation tool. Further, the conversion unit 344 may add an option string of an argument of the test automation tool to an argument string so that parameters used for the test scenario can be specified. Further, the conversion unit 344 converts test data (file) used for the test scenario into a format of an input file of the test automation tool.

Further, the conversion unit 344 may convert a result of the execution by the first test automation tool associated with the first test scenario into a format corresponding to the second test automation tool. By doing so, the linkage between a plurality of test automation tools used for the combined test can be automated. Further, the conversion unit 344 may convert information about a test corresponding to the second test scenario and a result of the execution by the first test automation tool together into a format corresponding to the second test automation tool. By doing so, the linkage between a plurality of test automation tools can be implemented in a flexible and highly advanced manner.

The test execution unit 345 is an example of the test execution unit 12 described above. The test execution unit 345 executes a test scenario selected by the selection unit 343 for the information system 1000 by using a test automation tool selected by the selection unit 343. Specifically, the test execution unit 345 specifies the selected test scenario and the test automation tool, and instructs the test execution apparatus 400 to execute the test for the information system 1000. At this time, the test execution unit 345 executes the selected test scenario by inputting information that has been converted by the conversion unit 344 into the selected test automation tool. Further, after execution of the first test automation tool, the test execution unit 345 executes the second test scenario by inputting information that has been converted for the second test automation tool into the selected second test automation tool.

The determination unit 346 is an example of the determination unit 13 described above. The determination unit 346 determines whether or not the combined test has been successfully performed based on at least some of results of the execution of a plurality of test scenarios executed in accordance with the respective execution orders. For example, the determination unit 346 may determine whether or not the combined test has been successfully performed from a result of the execution of the test scenario executed last. Alternatively, the determination unit 346 may determine whether or not the combined test has been successfully performed by taking into full account the results of the execution of a plurality of test scenarios.

At this time, the determination unit 346 may acquire an expected value of the combined test from the CMDB 200 and determine whether or not the combined test has been successfully performed using the expected value. Note that a part of the configuration information 210 in the CMDB 200 may be used as the expected value. By doing so, data in the configuration information database can be linked with a flow of the combined test.

Further, the determination unit 346 may generate a test result of the combined test based on some of the results of the execution of each of the test scenarios, and determine whether or not the combined test has been successfully performed by comparing the test result with the expected value. By doing so, the verification of the information system can be performed more accurately and efficiently.

Further, the determination unit 346 may acquire a result of the past determination registered by the registration unit 341 as the expected value from the CMDB 200. Specifically, the determination unit 346 may acquire the result of the most recent determination in the combined test result history information 220 of the CMDB 200 as the expected value of the present combined test.

Further, the selection unit 343, the conversion unit 344, the test execution unit 345, and the determination unit 346 may perform processing subsequently to completion of release processing executed by the release unit 342 in response to the update of the configuration information 210 of the information system 1000. By doing so, it is possible to conduct the configuration management, the release processing, and the combined test processing together, thus making it possible to speed up the release cycle.

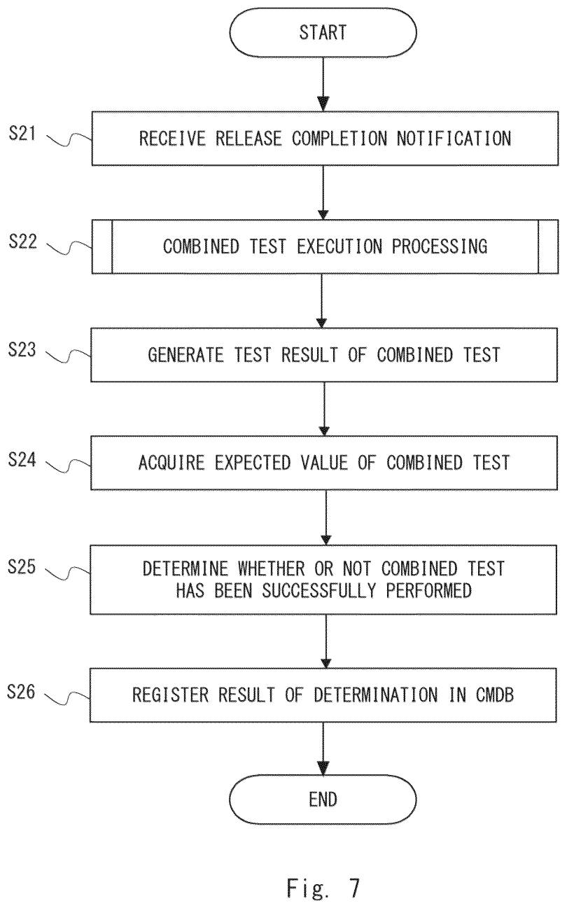

FIG. 7 is a flowchart showing a flow of combined test processing according to the second example embodiment. First, the selection unit 343 receives a release completion notification from the release unit 342 (S21). At this time, the release completion notification includes the combined test ID. Alternatively, the administrator terminal may specify the combined test ID in advance for the combined test apparatus 300. Next, the selection unit 343, the conversion unit 344, and the test execution unit 345 perform the combined test execution processing (S22).

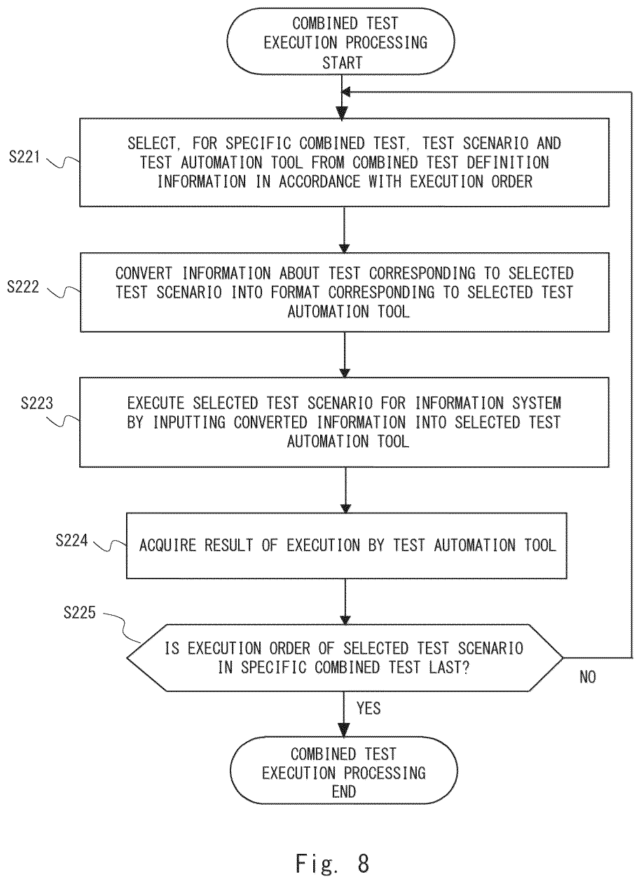

FIG. 8 is a flowchart showing a flow of combined test execution processing according to the second example embodiment. First, the selection unit 343 selects, for a specific combined test, a test scenario and a test automation tool from the combined test definition information 313 in accordance with an execution order (S221). It is assumed here that the specific combined test is included in a release completion notification or specified by an administrator terminal. For example, when the combined test ID “MT1” is included in the release completion notification, the selection unit 343 selects a pair of “TS01” and “TT01” associated with an execution order “1” of “MT1” from the combined test definition information 313.

Next, the conversion unit 344 converts information about the test corresponding to the selected test scenario into a format corresponding to the selected test automation tool (S222). Specifically, the conversion unit 344 specifies the host name “h1” and the test data “ppl.csv” associated with the test scenario ID “TS01” from the test scenario information 312. Then the conversion unit 344 converts the host name “h1” and the test data “ppl.csv” into an input format of the test automation tool “TT01”. For example, the conversion unit 344 generates “h1 ppl.csv” or the like as an argument string of the execution command of the test automation tool “TT01”.

Then, the test execution unit 345 executes the selected test scenario for the information system 1000 by inputting the converted information into the selected test automation tool (S223). Specifically, the test execution unit 345 specifies the test automation tool ID “TT01” and the argument string “h1 ppl.csv” and then provides an instruction to the test execution apparatus 400. In response to this, the test execution apparatus 400 analyzes the instruction, selects, for example, the test automation tool 401 corresponding to “TT01”, specifies the argument string “h1 ppl.csv” as the execution command of the test automation tool 401, and then executes it. Further, the test automation tool 401 acquires a result of the execution from the information system 1000, and outputs the result of the execution to the combined test apparatus 300. The test execution unit 345 acquires a result of the execution by the test automation tool 401 from the test execution apparatus 400 (S224).

Then, the selection unit 343 determines whether or not the execution order of the selected test scenario in the specific combined test is the last (S225). In the above example, since the execution order “2” is defined after “1” in “MT1” from the combined test definition information 313, it is determined that the execution order of the test scenario “TS01” executed in Step S223 is not the last (NO in S225).

Then, the selection unit 343 selects a pair of “TS11” and “TT02” associated with the execution order “2” of “MT1” from the combined test definition information 313 (S221). After that, similarly, Steps S222 to S225 are performed. Further, regarding the execution order “3” of “MT1”, similarly, Steps S221 to S225 are performed. At this time, immediately before Step S222, for example, the conversion unit 344 may convert a result of the execution of the tool corresponding to the test automation tool ID “TT02” and parameters and test data for the selected test scenario ID “TS12” into a format corresponding to the test automation tool ID “TT03”.

When it is determined that the execution order of the test scenario “TS12” executed in Step S223 is the last (YES in Step S225), the combined test execution processing is ended, and the process proceeds to Step S23 shown in FIG. 7.

Then, the determination unit 346 generates a test result of the combined test (Step S23). At this time, the determination unit 346 may generate a result of the combined test by taking into account the results of the execution of the tools corresponding to the test automation tool IDs “TT02” and “TT03”.

Then, the determination unit 346 acquires an expected value of the combined test (S24). For example, the determination unit 346 may acquire the result of the previous combined test “MT1” as an expected value from the combined test result history information 220 of the CMDB 200.

Then, the determination unit 346 determines whether or not the combined test has been successfully performed (S25). For example, when the determination unit 346 compares the test result generated in Step S23 with the expected value acquired in Step S24 and determines that the degree of matching between them is equal to or greater than a predetermined value, the determination unit 346 may determine that the combined test “MT1” has been successfully performed.

After that, the registration unit 341 registers a result of the determination in the CMDB 200 (S26). For example, the registration unit 341 associates the combined test ID “MT1”, the date and time of the execution of the combined test, the result of the combined test, and the result of the determination with each other and registers them in the combined test result history information 220 of the CMDB 200.

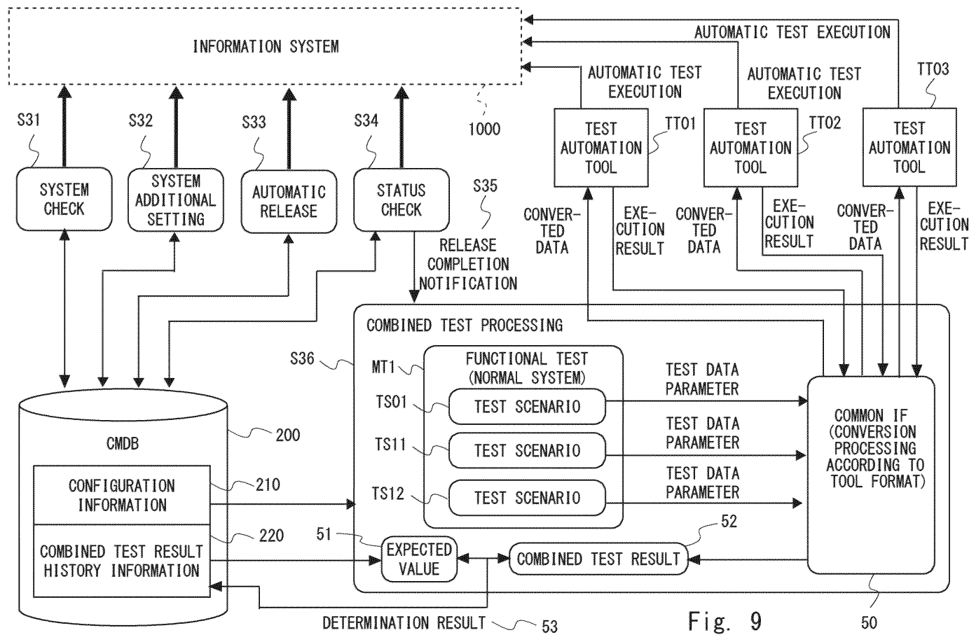

FIG. 9 is a diagram for explaining a concept of an automated pipeline for configuration management, release processing, and combined test processing according to the second example embodiment. For example, a developer terminal (not shown) registers updated contents of the configuration information 210 of the information system 1000 in the CMDB 200. In response to this, the release unit 342 detects the update of the configuration information 210 in the CMDB 200. Then, the release unit 342 checks whether or not the information system 1000 is in an updatable state (e.g., whether or not it is running properly at the present time) (S31).

Next, the release unit 342 performs additional setting on the information system 1000 in accordance with the updated contents of the configuration information 210 (S32). Then the release unit 342 acquires a source code or the like related to the updated configuration information, generates a load module, deploys (e.g., overwrites and saves) the load module in the information system 1000, and then releases the updated contents (S33). Since the release in Step S33 is executed without a manual operation, it may be referred to as an “automatic release”. Next, the release unit 342 performs a status check, such as a communication test, for the information system 1000 after the release is performed (S34). At this time, the release unit 342 may register a result of the status check in the CMDB 200. Further, when there is no problem with regard to the status check, the release unit 342 outputs a release completion notification including the combined test ID to the selection unit 343 (S35).

In response to this, the selection unit 343 and the like start the combined test processing described above (S36). Note that a common IF 50 in FIG. 9 corresponds to the conversion unit 344, the test execution unit 345, the determination unit 346, and the like described above. The common IF 50 converts the test data and the parameters for the first test scenario TS01 of the functional test (normal system) MT1 into a format of the test automation tool TT01. Then the common IF 50 specifies the converted data for the test automation tool TT01 and causes the test automation tool TT01 to execute. The test automation tool TT01 automatically executes the test for the information system 1000 by using the converted data. Then the test automation tool TT01 returns a result of the execution of the test to the common IF 50.

Next, the common IF 50 converts the test data and the parameters for the second test scenario TS11 of the functional test (normal system) MT1 into a format of the test automation tool TT02. At this time, the common IF 50 may perform the conversion including the result of the execution of the test automation tool TT01. Then the common IF 50 specifies the test automation tool TT02 for executing the converted data. The test automation tool TT02 automatically executes the test for the information system 1000 by using the converted data. Then the test automation tool TT02 returns a result of the execution of the test to the common IF 50.

Next, the common IF 50 converts the test data and the parameters for the third (last) test scenario TS12 of the functional test (normal system) MT1 into a format of the test automation tool TT03. At this time, the common IF 50 may perform the conversion including the result of the execution of the test automation tool TT02. Then the common IF 50 specifies the test automation tool TT03 for executing the converted data. The test automation tool TT03 automatically executes the test for the information system 1000 by using the converted data. Then the test automation tool TT03 returns a result of the execution of the test to the common IF 50.

After that, the common IF 50 generates a combined test result 52 using at least some of the results of the execution of the test automation tools TT01, TT02, and TT03. Further, the determination unit 346 acquires an expected value 51 from the combined test result history information 220, and determines whether or not the functional test (normal system) MT1 has been successfully performed by comparing the expected value 51 with the combined test result 52. Then the registration unit 341 registers a determination result 53 in the combined test result history information 220. Thus, the determination result 53 can be used as the expected value of the next functional test (normal system) MT1.

As described above, according to this example embodiment, when configuration information in the information system is changed, it is possible to automatically release target software to the system environment, and subsequently automate tests and verification of the normality of the service in the information system after the release is performed. Therefore, it is possible to speed up the automatic release cycle of the information system.

Further, the above-described technology disclosed in Patent Literature 1 is intended for automatic tests of the setting contents of the infrastructure environment of an information system. In contrast to this, this example embodiment is intended to automate a functional test, a non-functional test, and an operational test of an information system. Further, this example embodiment is not intended for a unit test of a program. It is instead intended for an integration test and a system test, that is, a combined test of an information system.

Further, in recent years, too many test automation tools for software tests have been provided, and the interfaces for linking the tools with each other have not been unified; for example, the specifications thereof differ for each programming language. Therefore, it is not easy to link various types of test automation tools with each other. According to this example embodiment, a plurality of types of test automation tools are associated with test scenarios by the combined test definition information 313 which defines them as jobs, whereby the transfer of data between the tools is specified by a job flow. Further, the conversion unit 344 converts data input to the test automation tool into an input format according to the tool. This configuration can support a different interface for each test automation tool. Further, the conversion unit 344 converts a result of the execution of the first test automation tool into an input format of the second test automation tool, whereby the test execution unit 345 can appropriately input data. Therefore, data can be smoothly transferred between the tools, and hence the tools can be easily linked with each other. Further, the determination unit 346 generates a result of the combined test by unifying the results of the execution of different types of different tools. This configuration can support a different interface for each test automation tool. As a result, it is possible to automate an integration test, a system test, and the like of the information system and thus to execute and verify a combined test efficiently.

### Other Example Embodiments

In the example described above, the program includes instructions (or software codes) that, when loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (Registered Trademark) disc or other types of optical disc storage, a magnetic cassette, a magnetic tape, and a magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the above-described example embodiments and may be changed as appropriate without departing from the scope and spirit of the present disclosure. Further, the present disclosure may be executed by combining the example embodiments with each other as appropriate.

The whole or part of the example embodiments disclosed above can be described as, but not limited to, the following supplementary notes.

### (Supplementary Note A1)

A combined test apparatus comprising:
selection means for referring to combined test definition information in which a test automation tool and an execution order are associated with each of a plurality of test scenarios constituting a combined test for an information system and then selecting the test scenario and the test automation tool in accordance with the execution order;
test execution means for executing, for the information system, the selected test scenario by using the selected test automation tool; and
determination means for determining whether or not the combined test has been successfully performed based on at least some of results of the execution of the plurality of the test scenarios executed in accordance with the respective execution orders.

### (Supplementary Note A2)

The combined test apparatus according to supplementary note A1, further comprising first conversion means for converting information about a test corresponding to the selected test scenario into a format corresponding to the selected test automation tool,
wherein the test execution means executes the selected test scenario by inputting the converted information into the selected test automation tool.

### (Supplementary Note A3)

The combined test apparatus according to supplementary note A1 or A2, wherein
the selection means selects a second test scenario and a second test automation tool, an execution order of the second test scenario being later than that of the first test scenario,
the combined test apparatus further comprises second conversion means for converting a result of the execution by the first test automation tool associated with the first test scenario into a format corresponding to the second test automation tool, and
the test execution means executes the second test scenario by inputting the converted information into the selected second test automation tool.

### (Supplementary Note A4)

The combined test apparatus according to any one of supplementary notes A1 to A3, wherein
the determination means acquires an expected value in the combined test from a configuration management database configured to manage configuration information of the information system,
the determination means determines whether or not the combined test has been successfully performed by using the expected value, and
the combined test apparatus further comprises registration means for registering a result of the determination by the determination means in the configuration management database.

### (Supplementary Note A5)

The combined test apparatus according to supplementary note A4, wherein the determination means generates a test result of the combined test based on some of the results of the execution of the respective test scenarios, and determines whether or not the combined test has been successfully performed by comparing the test result with the expected value.

### (Supplementary Note A6)

The combined test apparatus according to supplementary note A4 or A5, wherein the determination means acquires a result of the past determination registered by the registration means as the expected value from the configuration management database.

### (Supplementary Note A7)

The combined test apparatus according to any one of supplementary notes A1 to A6, wherein the selection means, the test execution means, and the determination means perform processing subsequently to completion of release processing executed in response to an update of the configuration information of the information system.

### (Supplementary Note A8)

The combined test apparatus according to any one of supplementary notes A1 to A7, wherein the combined test includes at least one of a functional test for verifying a function provided by the information system, a load test for verifying performance of the information system, and an abnormal system test for verifying an operation of the information system in an event of an abnormality.

### (Supplementary Note B1)

A combined test system comprising:
a storage apparatus configured to store combined test definition information in which a test automation tool and an execution order are associated with each of a plurality of test scenarios constituting a combined test for an information system; and
a combined test apparatus,
wherein the combined test apparatus comprises:
selection means for referring to the combined test definition information and then selecting the test scenario and the test automation tool in accordance with the execution order;
test execution means for executing, for the information system, the selected test scenario by using the selected test automation tool; and
determination means for determining whether or not the combined test has been successfully performed based on at least some of results of the execution of the plurality of the test scenarios executed in accordance with the respective execution orders.

### (Supplementary Note B2)

The combined test system according to supplementary note B1, wherein
the combined test apparatus further comprises first conversion means for converting information about a test corresponding to the selected test scenario into a format corresponding to the selected test automation tool, and
the test execution means executes the selected test scenario by inputting the converted information into the selected test automation tool.

### (Supplementary Note C1)

A combined test method comprising:
referring to combined test definition information in which a test automation tool and an execution order are associated with each of a plurality of test scenarios constituting a combined test for an information system and then selecting the test scenario and the test automation tool in accordance with the execution order;
executing, for the information system, the selected test scenario by using the selected test automation tool; and
determining whether or not the combined test has been successfully performed based on at least some of results of the execution of the plurality of the test scenarios executed in accordance with the respective execution orders.

### (Supplementary Note D1)

A non-transitory computer readable medium storing a combined test program for causing a computer to execute:
selection processing for referring to combined test definition information in which a test automation tool and an execution order are associated with each of a plurality of test scenarios constituting a combined test for an information system and then selecting the test scenario and the test automation tool in accordance with the execution order;
test execution processing for executing, for the information system, the selected test scenario by using the selected test automation tool; and
determination processing for determining whether or not the combined test has been successfully performed based on at least some of results of the execution of the plurality of the test scenarios executed in accordance with the respective execution orders.

Although the present invention has been described with reference to the example embodiments (and examples), the present invention is not limited to the above-described example embodiments (and examples). Various changes that may be understood by those skilled in the art may be made to the configurations and details of the present invention within the scope of the invention.

### REFERENCE SIGNS LIST

1 COMBINED TEST APPARATUS
11 SELECTION UNIT
12 TEST EXECUTION UNIT
13 DETERMINATION UNIT
N NETWORK
1000 INFORMATION SYSTEM
2000 COMBINED TEST SYSTEM
200 CMDB
210 CONFIGURATION INFORMATION
220 COMBINED TEST RESULT HISTORY INFORMATION
300 COMBINED TEST APPARATUS
310 STORAGE UNIT
311 COMBINED TEST PROGRAM
312 TEST SCENARIO INFORMATION
3121 TEST SCENARIO ID
3122 SCENARIO CONTENT
3123 HOST NAME
3124 TEST DATA
313 COMBINED TEST DEFINITION INFORMATION
3131 COMBINED TEST ID
3132 COMBINED TEST CONTENT
3133 EXECUTION ORDER
3134 TEST SCENARIO ID
3135 TEST AUTOMATION TOOL ID
320 MEMORY
330 COMMUNICATION UNIT
340 CONTROL UNIT
341 REGISTRATION UNIT
342 RELEASE UNIT
343 SELECTION UNIT
344 CONVERSION UNIT
345 TEST EXECUTION UNIT
346 DETERMINATION UNIT
400 TEST EXECUTION APPARATUS
401 TEST AUTOMATION TOOL
40n TEST AUTOMATION TOOL
50 COMMON IF
51 EXPECTED VALUE
52 COMBINED TEST RESULT
53 DETERMINATION RESULT
MT1 FUNCTIONAL TEST (NORMAL SYSTEM)
TS01 TEST SCENARIO
TS11 TEST SCENARIO
TS12 TEST SCENARIO
TT01 TEST AUTOMATION TOOL
TT02 TEST AUTOMATION TOOL
TT03 TEST AUTOMATION TOOL

What is claimed is:

1. A combined test apparatus comprising:
at least one storage device configured to store instructions; and
at least one processor configured to execute the instructions to:
refer to combined test definition information in which a test automation tool and an execution order are associated with each of a plurality of test scenarios constituting a combined test for an information system and then select the test scenario and the test automation tool in accordance with the execution order;
execute, for the information system, the selected test scenario by using the selected test automation tool; and
determine whether or not the combined test has been successfully performed based on at least some of results of the execution of the plurality of the test scenarios executed in accordance with the respective execution orders.

2. The combined test apparatus according to claim 1, wherein the at least one processor is further configured to execute the instructions to:
convert information about a test corresponding to the selected test scenario into a format corresponding to the selected test automation tool, and
execute the selected test scenario by inputting the converted information into the selected test automation tool.

3. The combined test apparatus according to claim 1, wherein the at least one processor is further configured to execute the instructions to:
select a second test scenario and a second test automation tool, an execution order of the second test scenario being later than that of the first test scenario,
convert a result of the execution by the first test automation tool associated with the first test scenario into a format corresponding to the second test automation tool, and
execute the second test scenario by inputting the converted information into the selected second test automation tool.

4. The combined test apparatus according to claim 1, wherein the at least one processor is further configured to execute the instructions to:
acquire an expected value in the combined test from a configuration management database configured to manage configuration information of the information system,
determine whether or not the combined test has been successfully performed by using the expected value, and
register a determined result in the configuration management database.

5. The combined test apparatus according to claim 4, wherein the at least one processor is further configured to execute the instructions to:
generate a test result of the combined test based on some of the results of the execution of the respective test scenarios, and determine whether or not the combined test has been successfully performed by comparing the test result with the expected value.

6. The combined test apparatus according to claim 4, wherein the at least one processor is further configured to execute the instructions to:
acquire a result of the past determination registered as the expected value from the configuration management database.

7. The combined test apparatus according to claim 1, wherein the at least one processor is further configured to execute the instructions to:
perform a process subsequently to completion of release processing executed in response to an update of the configuration information of the information system, the process including selecting the test scenario and the test automation tool, executing the selected test scenario, and determining whether or not the combined test has been successfully performed.

8. The combined test apparatus according to claim 1, wherein the combined test includes at least one of a functional test for verifying a function provided by the information system, a load test for verifying performance of the information system, and an abnormal system test for verifying an operation of the information system in an event of an abnormality.

9.-10. (canceled)

11. A combined test method comprising:
referring to combined test definition information in which a test automation tool and an execution order are associated with each of a plurality of test scenarios constituting a combined test for an information system and then selecting the test scenario and the test automation tool in accordance with the execution order;
executing, for the information system, the selected test scenario by using the selected test automation tool; and
determining whether or not the combined test has been successfully performed based on at least some of results of the execution of the plurality of the test scenarios executed in accordance with the respective execution orders.

12. A non-transitory computer readable medium storing a combined test program for causing a computer to execute:
selection processing for referring to combined test definition information in which a test automation tool and an execution order are associated with each of a plurality of test scenarios constituting a combined test for an information system and then selecting the test scenario and the test automation tool in accordance with the execution order;
test execution processing for executing, for the information system, the selected test scenario by using the selected test automation tool; and
determination processing for determining whether or not the combined test has been successfully performed based on at least some of results of the execution of the plurality of the test scenarios executed in accordance with the respective execution orders.
